(19) United States
(12) Patent Application Publication
(10) Pub. No.: US 2021/0158117 A1
(43) Pub. Date: May 27, 2021

(54) GEOFENCED-BASED LOST AND FOUND MOBILE DEVICE APPLICATION SYSTEM

(71) Applicant: HUGH A WILMOT, JR., Hastings-on-Hudson, NY (US)

(72) Inventor: HUGH A WILMOT, JR., Hastings-on-Hudson, NY (US)

(21) Appl. No.: 16/693,329

(22) Filed: Nov. 24, 2019

(51) Int. Cl. G06K 19/06; H04W 4/029; G06K 7/14; H04W 4/021; G06K 19/077; G08B 21/24

(52) U.S. Cl. CPC G06K 19/06037; H04W 4/029; G08B 21/24; H04W 4/021; G06K 19/0776; G06K 7/1417

(57) ABSTRACT

A geofenced-based lost and found mobile device application system for schools is disclosed. The system being comprised of three main parts: a first part being a mobile device (such as a smart phone, tablet etc.), a second part being a software application and a third part being Quick Response (QR) coded labels permanently affixed to student belongings. An object of the invention is to recover lost items within a predefined, physical property—such as in a kindergarten or grade school. The software having geofencing capabilities allowing administrators to define an area, distribute devices to personnel within said area called ‘hot spots’ and allowing them to scan lost items having QR Codes. Once an item is recovered, stakeholders then receiving notifications (such as a text, SMS etc.) in real time that their child's lost item has been found along with instructions on how to retrieve it.

### FIELD OF THE INVENTION

The present invention generally relates to mobile device applications. More specifically, it relates to a geofence-based lost and found system to enhance the recovery of lost items within a school.

### BACKGROUND

A lost and found is an area or office in a public building or where people can go to retrieve lost articles that may have been found by others. Frequently found at museums, amusement parks and schools, a lost and found will typically be a clearly marked box or room in a location near the main entrance. Some lost and found offices will try to contact the owners of any lost items if there are any personal identifiers available. Practically all will either sell, give or throw away items after a certain period has passed to clear their storage. The first evidence of a lost and found system dates back to Ancient Greece and Rome. In Japan, a lost-and-found property system has been found that dates back to the year 718. Centuries later in Paris, Napoleon ordered his prefect of police to establish a central place “to collect all objects found in the streets of Paris.”

Today, most public places and schools incorporate a lost and found policy as part of their operations. QR Codes have also gained in popularity in recent decades and offers a means to enhance lost item tracking. Expired U.S. Pat. No. 8,131,597B2 granted to Hudetz teaches of a system of scanners interacting with barcodes and QR Codes for products in a retail environment and are not part of a lost item retrieval system. U.S. Pat. No. 9,158,944B2 granted to Divringi & Bilgen teaches of a method to register and encode tags such as those found on QR Codes. However, the invention requires a tag to be coded with a plurality of information such as ‘intended uses’ rather than descriptive elements of an item that has been lost. U.S. Pat. No. 9,519,809B2 also granted to Divringi & Bilgen disclosed a method of associating tags with internet specific websites and does not facilitate lost and found objects. U.S. Pat. No. 6,259,367B1 granted to Klein disclosed a lost and found system using radio frequency tags but does not incorporate QR Codes. United States Patent No. 20120267430, granted to Penny et al., disclosed a bar-code or similar coding to be generated and tagged to a specific portable asset including such electronic devices as smart phones and laptop computers as well as various items of luggage including briefcases, purses, backpacks or the like; however, it is not part of a dedicated mobile device limited to a geo-fenced property. United States Patent No. 20130284804A1 granted to Saywa et. al. disclosed a QR Code tagging system for lost item retrieval tied to website notifications but again it is not part of a dedicated mobile device, nor is it limited to a geo-fenced property.

### SUMMARY OF THE INVENTION

The device herein disclosed and described provides a solution to the shortcomings in the prior art through the disclosure of a geofenced-based lost and found mobile device application system for schools. An object of the invention is to enhance the recovery of items lost by students by involving parents and guardians in the process. Parents purchase the software application for their smart phones and receive a packet containing several QR Code labels. These labels attach to a wide array of children's′ personal belongings—everything from water bottles, to books and clothing. Parents can then register a QR Code label using their smartphone's camera and the software and assign various attributes to the label. For example, a parent can affix a QR Code label to a child's water bottle, scan it with the software and then assign their child's name, a description of the bottle, their own contact information and even provide an image of the bottle. A physical duplicate QR Code label (or a digital version of the duplicate QR code) is retained by the parent (or child).

All of the information embedded in the QR Code label is encrypted and secure. It is coded and de-coded via a cloud network. For example, if a child loses the water bottle and it is found by or brought to an official, said official can scan the QR Code on the bottle using the proprietary mobile device (furnished to the school) and immediately notify the parent (and/or the children themselves if over 13 years old) of the bottle via a text message, email etc. This immediate notification allows a parent to be involved in the recovery thereby minimizing the risk the bottle remains in the school's possession for a prolonged period of time.

Another object of the invention is to minimize waste generated by unrecovered lost items in a school. Every school year, millions of children attend classes and misplace personal items on a regular basis. Some schools devote an entire room to lost and found and each year schools end up discarding boxes of unclaimed items. Some children are unaware the lost and found exists, others are too embarrassed to recover lost items. The invention intervenes in this process and increases the odds an item will be returned to a child thereby minimizing the amount of unclaimed and discarded items each year.

Another object of the invention is to ensure proper returns and avoid confusion in the lost and found. The invention includes a verification feature to ensure the item is paired with its proper owner. In the previous example, a parent was notified and the message included directions on how and when to pick up the water bottle. The location of the lost and found ‘hotspot’ is also determined using the proprietary mobile device's GPS system and notifies a parent exactly where the hotspot is located. When the parent (or child) arrives, they show their unique claim code sent with the notification message to lost and found officials. Said official then uses the verify feature in the mobile APP and re-scan's the lost item's QR Code to reveal the claim code to ensure a match. Such verification help lost items get returned to their rightful owners.

Another object of the invention is to limit lost items to a school grounds or facility of an administration's choosing. For example, many educational institutions combine K-12 facilities on a single campus. The invention allows the principle of the grade school portion of a campus to delineate an invisible boundary around a specific number of buildings or areas that are serviced by a particular lost and found office.

Another object of the invention is to increase awareness of lost items among stakeholders. In some instances, repeated loss of personal items by a child can be an indication of underlying issues. The parent version of the software keeps a record of findings and can be reviewed by a concerned parent at any time as a means of increasing awareness such events.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of stakeholders interacting with the invention.

FIG. 2 shows a perspective view of a QR Code being associated with a personal item.

FIG. 3 shows a diagrammatic view of the overall system setup.

FIG. 4 shows various flow diagrams of the invention method and process.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

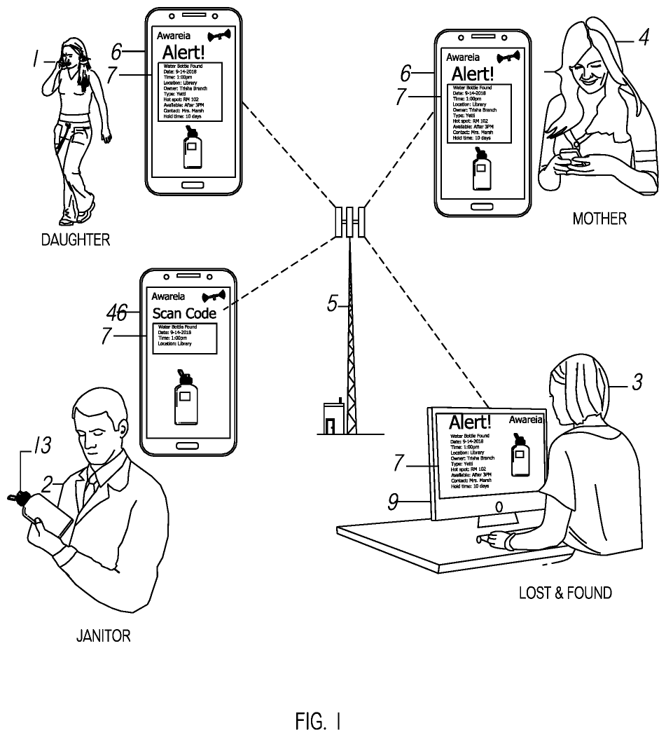

FIG. 1 shows a perspective view of stakeholders interacting with the invention. The figure depicting a daughter 1 who has misplaced a water bottle 13 and said water bottle being found by janitor 2 who scans the water bottle 2 with proprietary mobile device 46 and sends data to cloud network via wireless signal to cell phone tower 5. The software application algorithm locating the owner of said water bottle and sending an alert to daughter 1's mother 4, to the daughter 1 herself and to lost and found personnel 3.

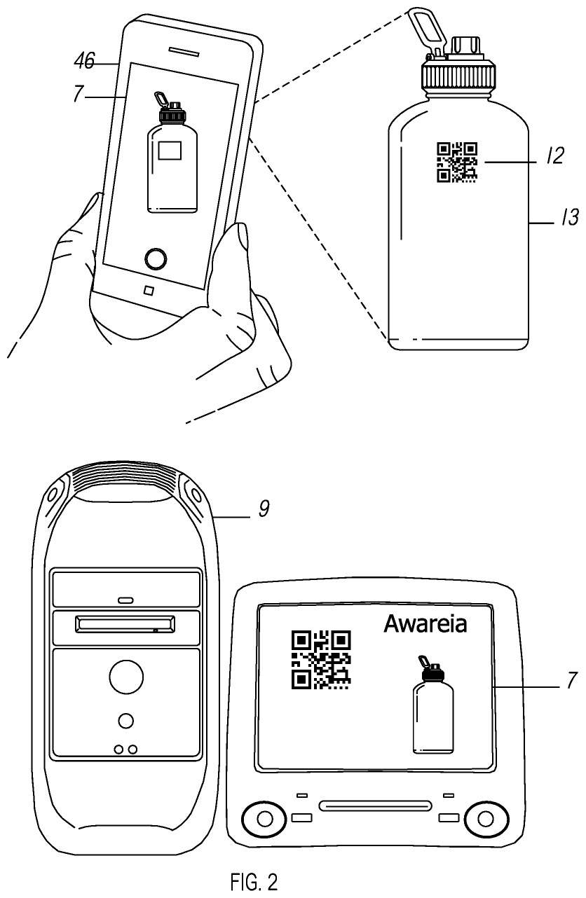

FIG. 2 shows a perspective view of a QR Code label 12 being associated with a personal item water bottle 13. The QR Code Label 12 being affixed to a plurality of personal items such as, but not limited to: clothing, computers, backpacks etc. by means of varietal of adhesives such as but not limited to: epoxies, fabric adhesives, double-sided tapes etc. The application software 7 allowing a user to scan the water bottle 13's QR Code label 12. Once scanned a user inputting a plurality of item attributes such as, but not limited to: owner name, telephone, email; item color, description and photos. The figure also showing a computer 9 being used to store and view water bottle 13 attributes therein. The aforementioned invention software being written from code that may include, but not be limited to: Java, C++, Visual Basic, Fortran, Basic and the like. The software also compatible with a plurality of operating systems such as, but not limited to: Windows Apple and Android and compatible with a multitude of hardware platforms such as, but not limited to: personal desktops, laptops, tablets, smartphones and the like.

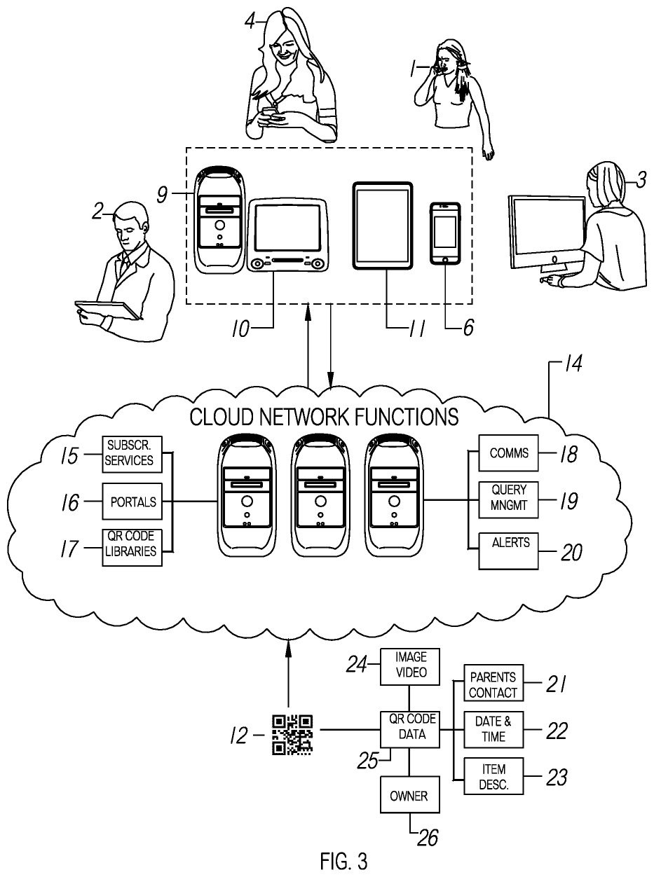

FIG. 3 shows a diagrammatic view of the overall system setup. Inputs into the cloud network 14 infrastructure back end being the programmed QR Code 12 having information associated with it on the invention's back end comprised of, but not limited to: digital images and video link 24, owner information text 26, parents contact information text 21, date and time text 22, and item description text 23. Said cloud network 14 having a plurality of algorithms performing routine operations such as, but not limited to: stakeholder subscription service management routines 15, stakeholder portals 16 with access rights therein, QR Code libraries 17 storing the various scans, stakeholder networking and communication handshaking 18, stakeholder query algorithms 19 and stakeholder alerts, reminders and notifications algorithms 20. All alerts and notifications being transmitted over, but not limited to: email, text, SMS, social network messages, phone recording and the like. The figure also showing the various end user terminals such as but not limited to: desktop computers 9, cable TVs 10, tablets 11, smart phones 6 and the like.

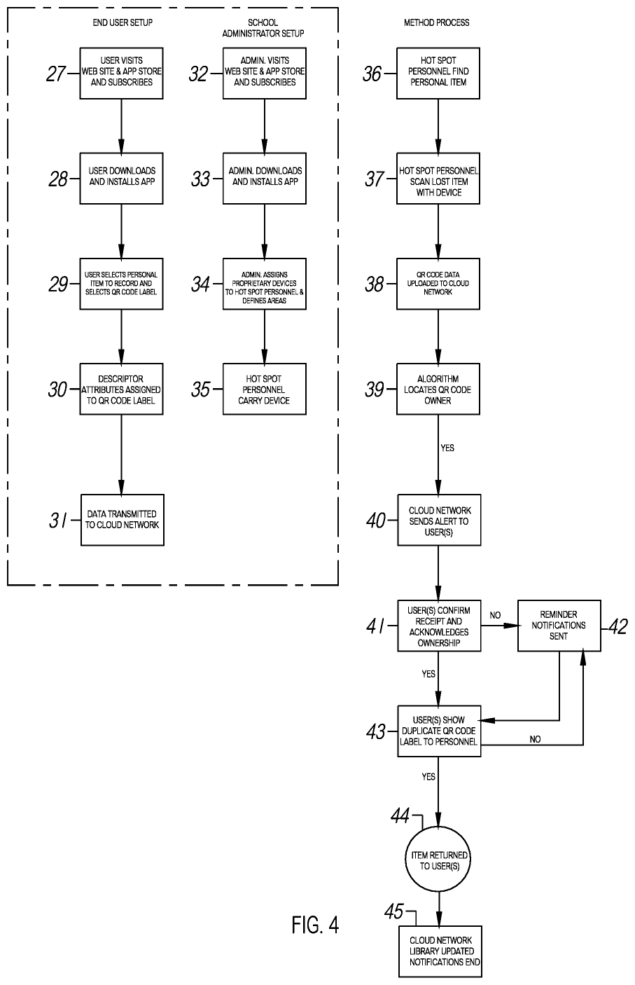

FIG. 4 shows various flow diagrams of the invention setup, method and process. In step 27 a user (such as, but not limited to a child and parent or guardian) downloading the software application and paying a fee for the subscription service. Said users downloading the software and install the application in step 28. In step 29 the user(s) selecting personal items to record and an associated QR Code label. In step 30 the user assigning a myriad of attributes to said QR Code label and submitting it to the cloud network in step 31.

FIG. 4 also showing setup routines for school administrators. In step 32 the administrators also subscribe to the service but does not pay a fee. In step 33 they download and install the invention software. In step 34 the administrator assigns proprietary devices (obtained by the manufacturer) to hotspot personnel responsible for coordinating finds and returns and having said devices on their persons during work hours in step 35. In this step the administrator also using the geofencing algorithms to define perimeter of hotspot boundaries therein.

Finally, FIG. 4 showing the method process of the invention. In step 36 hotspot personnel locating a lost item. In step 37 hotspot personnel scanning lost item's QR Code label and data being transmitted to cloud network 38. Said cloud network algorithms locating the owner in step 39. In step 40 the cloud sending an alert to users and owners. Owners confirm and acknowledge ownership using the invention software in step 41. If said owners or users not confirming ownership the cloud network sending a reminder in the form of a text, SMS and the like. In step 43 a user or owner arrives at a hotspot to claim said personal item by showing physical or digital QR Code label to personnel. Once returned, the hotspot personnel recording transaction to the cloud network in step 44 and the network updating the transaction as completed.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

1-14. (canceled)

15.) A lost and found system for schools comprised of the following parts:
(a) A non-transitory computer readable medium including computer readable instructions;
(b) QR Code labels with unique retrieval identification for placing on personal items;
(c) a scanning device for reading QR Code labels;
(d) a unique retrieval identification assigned to users; and
(e) a hotspot policy for the retrieval of lost and found items.

16) The lost and found system for schools of claim 15 wherein the non-transitory computer readable medium including computer readable instructions being compatible with existing Secure Quick Response Codes (“SQRC”) software databases and includes georeferencing features, a mobile device app, and a cloud network.

17.) The lost and found system for schools of claim 15 wherein the non-transitory computer readable medium including computer readable instructions having encryption.

18.) The lost and found system for schools of claim 15, wherein the non-transitory computer readable medium including geofencing operations that are linked to pre-determined longitude/latitude coordinates referred to as a ‘hotspots.’

19.) The lost and found system for schools of claim 15, wherein the non-transitory computer readable medium that allows a user to scan QR Code labels when they are within at least 10 meter radius of a hotspot.

20.) The lost and found system for schools of claim 15, wherein the non-transitory computer readable medium that automatically disables the scanning of QR Code labels when they are outside a radius of at least 10 meters of a hotspot.

21.) The lost and found system for schools of claim 15, wherein the non-transitory computer readable medium automatically displays the message “Message successfully sent” after scanning a QR Code label.

22.) The lost and found system for schools of claim 15, wherein the non-transitory computer readable medium automatically verifies the owner of the scanned QR Code label is in the database and alerts the owner with a text message and emails them the hotspot policy.

23.) The lost and found system for schools of claim 15, wherein the non-transitory computer readable medium automatically encourages the user to retrieve a lost item via a text message and email.

24.) The lost and found system for schools of claim 15, wherein the non-transitory computer readable medium compares the unique retrieval identification on the QR Code Label with the user's unique retrieval identification.

25.) The lost and found system for schools of claim 15 wherein the QR Code labels having adhesives on one side.

26.) The lost and found system for schools of claim 15 wherein the scanning device being compatible with QR Codes and connecting to the cloud network.

27.) A method of enhancing the recovery of lost student items in schools, comprising the following steps:
(a) distributing kits;
(b) defining operation areas;
(c) affixing identifiers to student belongings;
(d) registering student belongings;
(e) identifying lost student belongings;
(f) notifying stakeholders;
(g) instructing stakeholders on student belonging recovery process;
(h) verifying proper owners of student belongings;
personal belongings.

28.) The method of enhancing the recovery of lost student items in schools of claim 27 wherein the distributing kits including the QR Code labels of being sent to parents of students.

29.) The method of enhancing the recovery of lost student items in schools of claim 27 wherein the defining operation areas being performed by school administrators using the georeferencing.

30.) The method of enhancing the recovery of lost student items in schools of claim 27 wherein the affixing identifiers adhering the QR Codes labels to student personal belongings.

31.) The method of enhancing the recovery of lost student belongings in schools of claim 27 wherein the assigning of various attributes to the label being affixed to the student belongings using the software.

32.) The method of enhancing the recovery of lost student belongings in schools of claim 27 wherein the registering student belongings being performed by parents uploading the QR Code information to the cloud network.

33.) The method of enhancing the recovery of lost student belongings in schools of claim 27 wherein the identifying being performed by the scanner reading the QR Code label and obtaining owner information from the cloud network.

34.) The method of enhancing the recovery of lost student belongings in schools of claim 27 wherein the notifying stakeholders being performed by the cloud network sending notifications automatically.

35.) The method of enhancing the recovery of lost student belongings in schools of claim 27 wherein the instructing stakeholders on student belonging recovery process being performed by the cloud network sending the instructions in notifications automatically.

36.) The method of enhancing the recovery of lost student belongings in schools of claim 27 wherein the verifying proper owners of student belongings being performed by matching student information with information recorded on the cloud network.

37.) The method of enhancing the recovery of lost student items in schools of claim 27 wherein the defining operation areas being performed by school administrators using the georeferencing.
